(19) United States
(12) Patent Application Publication
(10) Pub. No.: US 2007/0269576 A1
(43) Pub. Date: Nov. 22, 2007

(54) Exotic fruit juice and silver-containing beverage

(76) Inventors: Brent Barton, Highland, UT (US); John Antonelli, Highland, UT (US)

Correspondence Address: Gary P. Oakeson, P.O. Box 1219, Sandy, UT, 84070-0562, US

(21) Appl. No.: 11/438,675

(22) Filed: May 18, 2006

(51) Int. Cl. A23L 2/00

(52) U.S. Cl. 426/599

(57) ABSTRACT

Fruit drinks and methods for providing positive health benefits to an individual are disclosed and described. In some aspects, a nutritional fruit drink is provided having a fruit juice selected from the group consisting of durian, mangosteen, gac, cili, lycium barbarum, seabuckthorn berry, hawthorn berry, euphoria longana, jujube date, schisandra berry, passion fruit, lychee, tangerine, coconut, rambulan, longkong, carambola, quanara, acai berry, qing mei, quinoa, and mixtures and concentrates thereof, and a silver source. Such fruit drinks can provide added nutrition to the diet while imparting increased protection against microorganismic infections.

### FIELD OF THE INVENTION

This invention relates to nutritional fruit juices. Accordingly, the invention involves the fields of nutritional and health sciences and medicine.

### BACKGROUND OF THE INVENTION

In the present fast-paced society, many individuals are plagued with poor health. Nutrition is often at odds with present eating habits, and is thus sacrificed for fast food diets and other preprocessed foods. To offset this trend, a large number of nutritional supplements and other health-beneficial products have become available and have generated much interest. Many such health supplements are derived from various fruits thought to contain beneficial compounds. It appears that certain health benefits may accrue when these compounds are taken regularly. For example, many fruits contain important carotenoids such as beta-carotene and lycopene, tocopherols, flavonoids, fatty acids, sterols, and phytosterols. These and other naturally occurring antioxidants and other phytonutrients may provide free radical scavenging protection and improved regeneration effects to the body's immune system. It has also been suggested that many of these compounds may reduce the effects of aging on the skin, increase vision, combat obesity, prevent skin conditions, and protect against cancer. Examples of fruits that may provide such protective functions are Gac, Durian, and other exotic fruits.

In addition to problems associated with nutritional deficiencies, another problem confronting society today is the growing antibiotic resistance in many harmful strains of microorganisms. As antibiotics have been increasingly used and misused, many bacterial strains have become resistant. It has been estimated that penicillin resistant pneumococcal resistance to penicillin has increased to nearly 30%. As the rates of such resistance increases, bacterial infections begin to have a greater impact on, and thus be more detrimental to, the health of individuals.

In view of the forging, nutritional formulations and methods which impart positive health benefits and/or provide protection against bacterial and other microorganismic infections or immunity continue to be sought.

### SUMMARY OF THE INVENTION

It has been recognized that a drink combining the benefits of various exotic fruits with the benefits of nutritional amounts of silver would provide positive health benefits. Thus, the present invention provides formulations that include quick and convenient sources of nutrition. In one aspect, a nutritional fruit drink or concentrate is provided having a fruit juice selected from the group consisting of durian, mangosteen, gac, cili, lycium barbarum, seabuckthorn berry, hawthorn berry, euphoria longana, jujube date, schisandra berry, passion fruit, tangerine, coconut, lychee, rambulan, longkong, carambola, quanara, acai berry, qing mei, quinoa, and mixtures and concentrates thereof, and a silver source. In another embodiment, a method of providing nutritional benefits to a subject can comprise orally administering the nutritional fruit drink to a subject.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting.

In describing and claiming the present invention, the following terminology is used.

The singular forms “a,” “an,” and “the” include plural referents unless the context clearly dictates otherwise. Thus, for example, reference to “a juice” includes reference to one or more of such juices.

As used herein, “subject” refers to a mammal that may benefit from the fruit juices according to aspects of the present invention. Most often, the subject will be a human.

As used herein, “extract” when used in connection with a plant, tree, herb, fungus, etc., refers to material which has been removed from the source, or a portion thereof, including the flower, fruit, seed, peel, leaf, root, bark, stem, etc. As will be recognized by those of ordinary skill in the art, extracts may be either crude or refined to a selected degree in order to isolate specified materials or active agents. A number of extraction processes that can be employed to produce the compositions of various types will be recognized by those skilled in the art, such as dehydration, lyophilization, CO₂ extraction, fractionation, solvent based extraction, combinations thereof, etc.

“Antioxidant” refers to a chemical compound, an enzyme or other organic molecule which prevents free radicals from causing oxidation of molecules in the body. Susceptible molecules include without limitation, such vital entities as DNA, RNA, lipids (fats), and proteins. The antioxidant, by reacting with the oxidant, protects these important molecules from being damaged. Examples of antioxidants include without limitation, vitamins A, C, E, carotenoids, polyphenols, and certain minerals.

As used herein, “ionic silver” refers to silver in an ionic form. Ionic silver molecules can be free in solution, complexed with a counter-ion as a metal salt, chelated, etc. If the fruit juices of the present invention are provided in a concentrated form, then if ionic silver is present, it will typically be present in the form of a salt or chelate. When water is added to the concentrate, the ionic silver can be brought into solution.

As used herein, “colloidal silver” refers to silver particles or colloids less than 1.0 μm in size. In one embodiment, these colloids can be evenly distributed throughout the fruit drink or concentrate. In some embodiments, shaking or mixing can be used to evenly distribute such colloids throughout the fruit drink prior to consumption, and in other embodiments, the silver colloids can be formulated such that they remain homogenously suspended throughout the mixture over a long period of time.

As used herein, a plurality of items, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

The nutritional value of many foods ingested in today's society has steadily declined. Additionally, the continuous use of many pharmaceuticals to treat bacterial infections has lead to many forms of antibiotic-resistant bacteria. It has been discovered that various unique formulations of fruit juices containing a silver source in order to combat these growing problems can be beneficial for multiple purposes. Many fruits contain compounds that can provide added nutrition, particularly given the poor nutritional habits of many individuals. Additionally, the ingestion of silver can protect the body from many forms of bacterial and other infection. Thus, compositions in the forms of liquid drinks or concentrates including certain exotic fruits and a silver source may provide important health enhancing benefits in a quick and convenient form.

In various aspects of the present invention, it is contemplated that the fruit drink or concentrate can contain one, two, three, or more different juices as described herein. Such juices can provide natural sources of fiber, vitamins, minerals, and various other nutrients and compounds that can provide various health benefits. For example, a nutritional fruit drink or concentrate is provided which can include at least one fruit juice selected from durian, mangosteen, gac, cili, lycium barbarum, seabuckthorn berry, hawthorn berry, euphoria longana, jujube date, schisandra berry, passion fruit, tangerine, coconut, lychee, rambulan, longkong, carambola, quanara, acai berry, qing mei, quinoa, and mixtures and concentrates thereof. In another aspect, the fruit juice can include at least two fruit juices selected from the group consisting of durian, mangosteen, gac, cili, lycium barbarum, seabuckthorn berry, hawthorn berry, euphoria longana, jujube date, schisandra berry, lychee, rambulan, longkong, carambola, quanara, acai berry, qing mei, quinoa, and concentrates thereof. In a further aspect, the fruit juice can include at least three fruit juices selected from the group consisting of durian, mangosteen, gac, cili, lycium barbarum, seabuckthorn berry, hawthorn berry, euphoria longana, jujube date, schisandra berry, passion fruit, lychee, rambulan, longkong, carambola, quanara, acai berry, qing mei, quinoa, and concentrates thereof. Without being limiting, one particularly useful combination of juices can include durian and/or mangosteen. In another embodiment, the combination of juices can include one, two, or all three of euphoria longana, hawthorn berry, and lycium barbarum. In still other embodiments, durian, mangosteen, euphoria longana, hawthorn berry, and lycium barbarum can be combined in any combination to form a juice blend or concentrate. In still another specific aspect, durian and mangosteen can be mixed with at least one of gac, quanara, and acai berry. Though any functional amount of exotic fruit(s) can be present in the liquid compositions of the present invention, typically, the total amount of exotic fruit as listed herein will be from about 5 wt % to 100 wt % (less the amount of silver present).

In addition to the exotic fruits listed and described above, other secondary juices can be added for taste, cost considerations, nutritional benefit, filler, etc., and are not considered to be “exotic fruits” in accordance with embodiments of the present invention. For example, such secondary fruit(s) can include pineapple, orange, lemon, grapefruit, grape, cranberry, raspberry, blackberry, banana, apple, strawberry, peach, blueberry, cherry, and mixtures and concentrates thereof. Secondary fruits can be present at from 0 wt % to about 98 wt %, depending primarily on how much exotic fruit is desired for use.

Fruit juices, e.g., exotic fruits and secondary fruits, for inclusion in the fruit drinks according to aspects of the present invention may be prepared by any means known to one of ordinary skill in the art. For example, the fruits may be juiced, blended, pureed, crushed, squeezed, cooked, etc. Additionally, fruit juices may be included as extracts, powders, or concentrates, either as-is or in a reconstituted form.

In addition to the juices per se, the fruit drink or concentrate of the present invention can include a silver source, e.g., ionic silver and/or colloidal silver, mixed with exotic juice or exotic juice blend. Silver has is beneficial against various microorganisms when delivered orally. The ingestion of silver can reduce or eliminate certain existing prokaryotic and eukaryotic infections, as well as provide resistance to future infections of such organisms. It is contemplated that various forms of silver can be ingested, and thus, various silver sources alone or in combination can be used according to aspects of the present invention. For example, in one aspect of the present invention, the silver source can be ionic silver. As described above, ionic silver includes silver molecules in an ionic form. Ionic silver may be free in solution, mixed or complexed with a counter-ion, chelated, etc. Silver salts can include, without limitation, silver nitrate, silver acetate, silver citrate, silver oxide, silver carbonate, etc. In another aspect, the silver source can be colloidal silver. Colloidal silver generally includes silver particles or colloids less than about 1.0 μm in size. In one aspect, colloidal silver can have an average particle size of from about 0.001 μm to about 1.0 μm. In another aspect, colloidal silver can have an average particle size of from about 0.001 μm to about 0.1 μm. In yet another aspect, colloidal silver can have an average particle size of from about 0.03 μm to about 0.5 μm. In yet another aspect, the average particle size of the colloidal silver can be from about 0.35 μm to about 0.45 μm. Additionally, the silver source can include silver particles of a size greater than about 1.0 μm. These larger colloidal particles are sometimes referred to as silver protein. Exemplary colloidal silvers that can be used include those sold under the names ASAP, SOVEREIGN SILVER, SILVER MAX, CS ULTRA, CS PLUS, and the like. This being stated, the silver source can be ionic silver, colloidal silver, or it can include a mixture of ionic and colloidal silver.

A silver source can also be provided as an alloy of a transition metal. Certain alloys may allow more effective protection against specific pathogens. Non-limiting examples of such alloys can include copper-silver alloys, manganese-silver alloys, chromium-silver alloys, gold-silver alloys, magnesium-silver alloys, etc.

The silver content can be included in the fruit drinks of the present invention in concentrations that can be highly variable, depending on the desired use of the drink. For example, in one aspect, the concentration of silver (colloidal and/or ionic) can be from 0.001 ppm to 10,000 ppm by weight. In another aspect, the concentration of silver can be from about 0.1 ppm to about 1,000 ppm by weight. In another aspect, the concentration of silver can be from about 0.1 ppm to about 100 ppm by weight. In yet another aspect, the silver concentration can be from about 1 ppm to about 20 ppm by weight.

Vitamin ingredients can also be included in the fruit drinks according to various aspects of the present invention to impart additional nutritional value thereto. Any vitamin known to one of ordinary skill in the art can be included, depending on the desired nutritional effects of the resulting fruit drink. In one aspect, the vitamin ingredient can include a water soluble vitamin. Non-limiting examples of water soluble vitamins can include Vitamin B₁, B₂, B₃, B₅, B₆, B₁₂, B₁₃, B₁₅, B₁₇, biotin, Vitamin C, Vitamin P, choline, para-aminobenzoic acid (PABA), folic acid, inositol, and mixtures thereof. In another aspect, the vitamin ingredient can include an oil soluble vitamin. Non-limiting examples of oil soluble vitamins can include, without limitation, Vitamin A, Vitamin D, Vitamin E, Vitamin K, and mixtures thereof. In yet another aspect, a fruit drink can be formulated to include both water soluble vitamins and oil soluble vitamins. The amount of vitamin(s) present can be related to the recommended daily allowance, though any safe concentration can be present.

In addition to the fruit juices described herein, other herbal and botanical ingredients and extracts may be incorporated into the fruit drinks of the present invention that may impart positive health benefits. Generally, herbal and botanical ingredients and extracts are made from all kinds of herb and botanic sources and formulated based on a desired therapeutic function. Various therapeutic functions may include, for example, anti-flu, bone/joint, brain function, cardiovascular, circulatory, diet, depression, digestion, energy, eye vision, general health, immune system, liver, men's health respiratory, rest, urinary tract, women's health, etc. Non-limiting examples of herbal and botanical ingredients for inclusion in the present formulation can be selected from, but not limited to, aloe vera, astragalus, chammomile, cinnamon bark, cordyceps, coriolus versicolor, dandelion, dan shen, dong quai, echinacea, garlic, ginger, ginseng, ginko biloba, grape seed, gynostemma, hempseed, ho shou wu, kava kava, licorice root, milk thistle, mushroom, noni, nopal, notginseng, rhodiola rosea, rose hips, saw palmetto, St. John's Wort, valerian, and mixtures thereof. The amount of herbal and botanical ingredients included in the fruit drinks of the present invention may vary depending on the ingredient and the intended benefits to be derived from the fruit drink. In one aspect, however, the amount of the herbal ingredient may range from about 0.1 wt % to about 50 wt %.

Phytonutrients are compounds derived from plants that are thought to have various health-protecting qualities. Any phytonutrient can be included in the fruit drinks of the various aspects of the present invention to provide a particular benefit. Moreover, multiple phytonutrients can be included in order to further increase the nutritional value of the drink. Various non-limiting examples include resveratrols, chlorogenic acids, phloridzins, phloretins, anthocyanidins, polyphenols, ellagic acids, astrones, catechins, quercetols, epicatectins, p-coumaric acids, gallic acids, proanthocyanidole B1, B2, and B3, and mixtures thereof. Phytonutrients, if present, can be present at from 0.1 wt % to about 10 wt %, though amounts outside of this range are also included in the context of the present invention.

Many protective compounds found in plants possess antioxidant properties. Antioxidants may function to neutralize free radicals in the body that may be at least partially responsible for premature aging, heart disease, and cancer. Free radicals are highly reactive byproducts of chemical processes that occur in the body that produce harmful oxidation reactions which damage the integrity of cells and body tissues. It has also been recognized that antioxidants promote strong and healthy immune system, aid in the development of white blood cells, help maintain cell membrane integrity and reduce plaque formation which promote heart disease. For these reasons herbal supplements containing antioxidants have increased in use in recent years. Accordingly, in one aspect a fruit drink may further include at least one antioxidant in an amount of about 0.1 wt % to about 10 wt %. Certain antioxidant compounds have higher potencies and have slightly different functions. For example, and without limitation, carotenoids, polyphenols, tocopherols, and flavonoids can be useful antioxidants.

In certain aspects of the present invention, various other ingredients can be included in the fruit drinks. For example, in one aspect, at least one ionic mineral (other than silver) can be included. Such ionic minerals can include cations or anions. In some aspects, both cationic and anionic mineral ingredients can be included in a fruit drink. It is also contemplated that various amino acids can be included in a fruit drink formulation. In one aspect, at least one amino acid ingredient can be included in an amount from about 0.1 wt % to about 10 wt %. Exemplary minerals that can be present include calcium, magnesium, manganese, chromium, iron, zinc, copper, potassium, selenium, etc., in salt form, ionic form, chelated form, etc.

Amino acids can be included in a fruit drink as single amino acids, peptides, and/or proteins. Examples of beneficial amino acids can include, without limitation, alanine, arginine, carnitine, gamma-aminobutyric acid, glutamine, glycine, histidine, lysine, methionine, N-acetyl cysteine, ornithine, phenylalanine, taurine, tyrosine, valine, and mixtures thereof.

In addition to the ingredients described above, it is noted that any other ingredient can be added that is useful for formulating the compositions of the present invention. Such ingredients include various preservative, sweeteners, fillers, and the like, which can be used for various purposes including modification of the taste and shelf-life of fruit drinks.

### EXAMPLES

It is to be understood that while the invention has been described in conjunction with the preferred specific embodiments thereof, that which follows is intended to illustrate and not limit the scope of the invention. Other aspects of the invention will be apparent to those skilled in the art to which the invention pertains.

### Example 1

| Ingredients | Composition (%, w/w) |
|---|---|
| Mangosteen | 5-15% |
| Gac | 10-20% |
| Pineapple | 2-10% |
| Colloidal Silver | 10-100 ppm |
| Other¹ | balance |

### Example 2

| Ingredients | Composition (%, w/w) |
|---|---|
| Mangosteen | 10-20% |
| Cili Fruit | 2-10% |
| Colloidal Silver | 100-250 ppm |
| Other¹ | balance |

### Example 3

| Ingredients | Composition (%, w/w) |
|---|---|
| Durian | 5-15% |
| Mangosteen | 5-15% |
| Quanara | 2-10% |
| Acai Berry | 2-10% |
| Colloidal Silver | 250-500 ppm |
| Other¹ | balance |

### Example 4

| Ingredients | Composition (%, w/w) |
|---|---|
| Euphoria Longana | 20-30% |
| Hawthorn Berry | 10-20% |
| Lycium Barbarum | 15-25% |
| Rhodiola Rosea | 15-25% |
| Astragalus | 15-25% |
| CS ULTRA colloidal silver (100 ppm) | 10-100 ppm |
| Other¹ | balance |

### Example 5

| Ingredients | Composition (%, w/w) |
|---|---|
| Euphoria Longana | 5-15% |
| Hawthorn Berry | 3-10% |
| Lycium Barbarum | 10-20% |
| Jujube Date | 5-15% |
| Schisandra Berry | 3-10% |
| Seabuckthorn Berry | 3-10% |
| Gac | 3-10% |
| Mangosteen | 3-10% |
| Tangerine Peel | 3-10% |
| Astragalus | 10-20% |
| Rhodiola Rosea | 3-10% |
| Coriolus Versicolor | 3-10% |
| Ginger | 3-10% |
| CS ULTRA colloidal silver (100 ppm) | 10-100 ppm |
| Other¹ | balance |

### Example 6

| Ingredients | Composition (%, w/w) |
|---|---|
| Mangosteen | 5-15% |
| Quanara | 2-10% |
| Acai Berry | 2-10% |
| Ionic silver | 250-500 ppm |
| Other¹ | balance |

### Example 7

| Ingredients | Composition (%, w/w) |
|---|---|
| Euphoria Longana | 20-30% |
| Hawthorn Berry | 10-20% |
| Lycium Barbarum | 15-25% |
| Rhodiola Rosea | 15-25% |
| Astragalus | 15-25% |
| Ionic silver | 10-100 ppm |
| Other¹ | balance |

¹In Examples 1-7, “Other” may include water, other juices, fillers, preservatives, sweeteners, amino acids, phytonutrients, herbs, vitamins, and/or other additional ingredients, etc.

### Example 8

The liquid compositions described in Examples 1-7 are concentrated or dehydrated by conventional methods to form a fruit drink/silver concentrates or powders. Alternatively, individual fruit juice components can be concentrated individually, and the concentrate can be included in a fruit juice mixture, thus, altering the wt % set forth in Examples 1-7 because of its concentrated form.

It is to be understood that the above-described arrangements are only illustrative of the application of the principles of the present invention. Numerous modifications and alternative arrangements may be devised by those skilled in the art without departing from the spirit and scope of the present invention. Thus, while the present invention has been fully described above with particularity and detail in connection with what is presently deemed to be the most practical and preferred embodiments of the invention, it will be apparent to those of ordinary skill in the art that numerous modifications, including, but not limited to, variations in materials, form, function, and use may be made without departing from the principles and concepts set forth herein.

What is claimed is:

1. A nutritional fruit drink, comprising:
a fruit juice selected from the group consisting of durian, mangosteen, gac, cili, lycium barbarum, seabuckthorn berry, hawthorn berry, euphoria longana, jujube date, schisandra berry, passion fruit, lychee, tangerine, coconut, rambulan, longkong, carambola, quanara, acai berry, qing mei, quinoa, and mixtures and concentrates thereof; and
a silver source.

2. The fruit drink of claim 1, wherein the fruit juice includes at least two fruit juices selected from the group consisting of durian, mangosteen, gac, lycium barbarum, seabuckthorn berry, hawthorn berry, euphoria longana, jujube date, schisandra berry, lychee, rambulan, longkong, carambola, quanara, acai berry, qing mei, quinoa, and mixtures and concentrates thereof.

3. The fruit drink of claim 2, wherein the at least two fruit juices includes at least two members selected from the group consisting of mangosteen, gac, cili, lycium barbarum, seabuckthorn berry, hawthorn berry, euphoria longana, jujube date, schisandra berry, and mixtures and concentrates thereof.

4. The fruit drink of claim 1, wherein the fruit juice includes at least three fruit juices selected from the group consisting of durian, mangosteen, gac, cili, lycium barbarum, seabuckthorn berry, hawthorn berry, euphoria longana, jujube date, schisandra berry, passion fruit, lychee, rambulan, longkong, carambola, quanara, acai berry, qing mei, quinoa, and mixtures and concentrates thereof.

5. The fruit drink of claim 4, wherein the at least three fruit juices includes euphoria longana, hawthorn berry, and lycium barbarum.

6. The fruit drink of claim 1, wherein the silver source is ionic silver.

7. The fruit drink of claim 1, wherein the silver source is colloidal silver.

8. The fruit drink of claim 7, wherein the colloidal silver has an average particle size range of from about 0.001 μm to 1.0 μm.

9. The fruit drink of claim 7, wherein the colloidal silver has an average particle size range of from about 0.001 μm to 0.1 μm.

10. The fruit drink of claim 1, wherein the silver content of the silver source is present in the fruit drink in an amount from about 0.001 ppm to about 10,000 ppm.

11. The fruit drink of claim 1, wherein the silver content of the silver source is present in the fruit drink in an amount from about 0.1 ppm to about 100 ppm.

12. The fruit drink of claim 1, wherein the silver content of the silver source is present in the fruit drink in an amount from about 1 ppm to about 20 ppm.

13. The fruit drink of claim 1, further comprising at least on herb.

14. The fruit drink of claim 13, wherein the at least one herb includes a member selected from the group consisting of aloe vera, astragalus, chammomile, cinnamon Bark, cordyceps, coriolus versicolor, dandelion, dan shen, dong quai, echinacea, garlic, ginger, ginseng, ginko biloba, grape seed, gynostemma, hempseed, ho shou wu, kava kava, licorice root, milk thistle, mushroom, noni, nopal, notginseng, rhodiola rosea, rose hips, saw palmetto, St. John's Wort, valerian, and mixtures thereof.

15. The fruit drink of claim 13, wherein the at least one herb includes a member selected from the group consisting of astragalus, coriolus versicolor, echinacea, ginger, ginseng, ginko biloba, rhodiola rosea, and combinations thereof.

16. The fruit drink of claim 13, wherein the fruit drink includes at least one of astragalus and rhodiola rosea.

17. The fruit drink of claim 1, further comprising at least one vitamin ingredient.

18. The fruit drink of claim 17, wherein the at least one vitamin ingredient is a water-soluble vitamin.

19. The fruit drink of claim 18, wherein the at least one water-soluble vitamin includes a member selected from the group consisting of Vitamin B₁, B₂, B₃, B₅, B₆, B₁₂, B₁₃, B₁₅, B₁₇, Biotin, Vitamin C, Vitamin P, choline, para-aminobenzoic acid, folic acid, inositol, and mixtures thereof.

20. The fruit drink of claim 17, wherein the at least one vitamin ingredient is an oil-soluble vitamin.

21. The fruit drink of claim 20, wherein the oil-soluble vitamin is a member selected from the group consisting of: Vitamin A, Vitamin D, Vitamin E, Vitamin K, and mixtures thereof.

22. The fruit drink of claim 1, further comprising at least one ionic mineral ingredient.

23. The fruit drink of claim 22, wherein the at least one ionic mineral ingredient is selected from the group consisting of calcium, magnesium, manganese, chromium, iron, zinc, copper, potassium, and selenium.

24. The fruit drink of claim 22, wherein the at least one ionic mineral ingredient is in salt form, ionic form, or chelated form.

25. The fruit drink of claim 1, further comprising at least one amino acid ingredient.

26. The fruit drink of claim 25, wherein the at least one amino acid ingredient is a member selected from the group consisting of alanine, arginine, carnitine, gamma-aminobutyric acid, glutamine, glycine, histidine, lysine, methionine, N-acetyl cysteine, ornithine, phenylalanine, taurine, tyrosine, valine, and mixtures thereof.

27. The fruit drink of claim 1, further comprising at least one antioxidant.

28. The fruit drink of claim 1, further comprising at least one phytonutrient.

29. The fruit drink of claim 28, wherein the at least one phytonutrient includes a member selected from the group consisting of resveratrols, chlorogenic acids, phloridzins, phloretins, anthocyanidins, polyphenols, ellagic acids, astrones, catechins, quercetols, epicatectins, p-coumaric acids, gallic acids, proanthocyanidole B1, B2, and B3, and mixtures thereof.

30. The fruit drink of claim 1, further comprising a secondary fruit juice selected from the group consisting of pineapple, orange, lemon, grapefruit, grape, cranberry, raspberry, blackberry, banana, apple, strawberry, peach, blueberry, cherry, and mixtures and concentrates thereof.

31. The fruit drink of claim 1, in concentrated form.

32. The fruit drink of claim 1, wherein the silver source is a silver alloy.

33. A method of providing nutritional benefits to a subject, comprising orally administering a nutritional fruit drink to a subject, said fruit drink comprising a fruit juice and a silver source, said fruit juice selected from the group consisting of durian, mangosteen, gac, cili, lycium barbarum, seabuckthorn berry, hawthorn berry, euphoria longana, jujube date, schisandra berry, passion fruit, lychee, tangerine, coconut, rambulan, longkong, carambola, quanara, acai berry, qing mei, quinoa, and mixtures and concentrates thereof.

34. The method of claim 33, wherein the fruit juice includes at least two fruit juices selected from the group consisting of durian, mangosteen, gac, lycium barbarum, seabuckthorn berry, hawthorn berry, euphoria longana, jujube date, schisandra berry, lychee, rambulan, longkong, carambola, quanara, acai berry, qing mei, quinoa, and mixtures and concentrates thereof.

35. The method of claim 33, wherein the fruit juice includes at least three fruit juices selected from the group consisting of durian, mangosteen, gac, cili, lycium barbarum, seabuckthorn berry, hawthorn berry, euphoria longana, jujube date, schisandra berry, passion fruit, lychee, rambulan, longkong, carambola, quanara, acai berry, qing mei, quinoa, and mixtures and concentrates thereof.

36. The method of claim 33, wherein the silver source is ionic silver.

37. The method of claim 33, wherein the silver source is colloidal silver.

38. The method of claim 33, further comprising at least one herb, vitamin, mineral, amino acid ingredient, antioxidant, or phytonutrient.

39. The method of claim 33, further comprising a secondary fruit juice selected from the group consisting of pineapple, orange, lemon, grapefruit, grape, cranberry, raspberry, blackberry, banana, apple, strawberry, peach, blueberry, cherry, and mixtures and concentrates thereof.
